(19) United States
(12) Patent Application Publication
(10) Pub. No.: US 2026/0336003 A1
(43) Pub. Date: Oct. 29, 2026

(54) LIGHT SHIELD ASSEMBLY AND METHODS OF ASSEMBLING AND USING SAME

(71) Applicant: PulseForge, Inc., Austin, TX (US)

(72) Inventors: Ara W. Parsekian, Georgetown, TX (US); Kurt A. Schroder, Coupland, TX (US); Vahid Akhavan Attar, Austin, TX (US); Jesse M.M. Liberty, Austin, TX (US)

(21) Appl. No.: 19/656,228

(22) Filed: Apr. 23, 2026

Related U.S. Application Data
(60) Provisional application No. 63/793,379, filed on Apr. 23, 2025.

(51) Int. Cl. B23K 1/005; B23K 1/00

(52) U.S. Cl. CPC B23K 1/005; B23K 1/0016

(57) ABSTRACT

A light shield assembly for thermal processing of at least one electronics structure and associated components and methods. A method of thermally processing at least one electronics structure includes providing an electronics structure including multiple electronics structure portions, arranging shielding with respect to the at least one electronics structure, and illuminating the shielding and the electronics structure portions with one or more pulses of incoherent light for thermally processing the electronics structure portions. The shielding at least partially overlies each respective electronics structure portion to obstruct illumination of some of the respective electronics structure portion.

### CROSS-REFERENCE TO RELATED APPLICATIONS

This application claims the benefit of United States Provisional Application No. 63/793,379, filed Apr. 23, 2025, and United States Provisional Application No. 63/821,288, filed Jun. 10, 2025, each of which is hereby incorporated herein by reference in its entirety.

### FIELD

The present disclosure relates to light masking apparatuses and, more specifically, to a light shield assembly for the optical processing of electronics structures during electronics manufacturing.

### BACKGROUND

High-intensity light sources, such as xenon flashlamps and lasers, provide marked advantages in electronics structure manufacturing (the fabrication and assembly of substrates, wafers, circuit boards, flex boards, interposers, chips, modules, displays, etc.) over conventional heating mechanisms like steady-state ovens and other convective heat sources in many contexts. These light sources can be used to provide high amounts of energy in short, controllable periods to enable fast, efficient processing of electronics structures in operations such as soldering, sintering, bonding, ablation, etc. However, when sources of incoherent light with comparatively broad illumination areas are used for electronics processing operations, thermally sensitive components are susceptible to damage if not covered by masks or other mitigating elements.

The accuracy of traditional masks can provide unwanted complications in the manufacturing of small electronics devices that are susceptible to misaligned and warped light shield structures. Due to the intensity of the pulses of light emitted from the light sources contemplated herein, even relatively reflective light shield materials, such as aluminum, absorb enough light to cause rapid thermal expansion across the light shield, which compounds across the area of a light shield, which results in reduced yields and higher quality control.

### SUMMARY

In one aspect, a method of thermally processing at least one electronics structure includes providing multiple electronics structure portions, arranging shielding with respect to the electronics structure portions, and illuminating the shielding and the electronics structure portions with one or more pulses of incoherent light for thermally processing the electronics structure portions. The shielding at least partially overlies each respective electronics structure portion to obstruct illumination of some of the respective electronics structure portion.

Other objects and features will be in part apparent and in part pointed out hereinafter.

### BRIEF DESCRIPTION OF THE DRAWINGS

Aspects of the present disclosure, including various embodiments, further objects, and advantages thereof, will best be understood by reference to the following detailed description when read in conjunction with the accompanying drawings, wherein:

FIG. 1 is schematic of a light shield apparatus in accordance with one aspect of the present disclosure;

FIG. 2 is a schematic of the light shield apparatus in combination with an electronics structure located in a receiving space;

FIG. 3 is a schematic of the light shield apparatus in combination with two electronics structures located in the receiving space;

FIG. 4 is a schematic of the light shield apparatus when exposed to a pulse of light covering the light shield thereof;

FIG. 5 is a schematic of the light shield apparatus when exposed to a sequence of pulses of light, each pulse of light covering a different portion of the light shield;

FIG. 6 is a schematic of a compound light shield apparatus in accordance with another aspect of the present disclosure, in combination with a plurality of electronics structures located in respective receiving spaces;

FIG. 7 is a schematic of the compound light shield apparatus in combination with a plurality of electronics structures, each being located in a corresponding group of receiving spaces;

FIG. 8 is a schematic of the compound light shield apparatus in combination with an electronics structure located in a plurality of receiving spaces;

FIG. 9 is a schematic of the compound light shield apparatus when exposed to a sequence of pulses of light, each pulse of light covering a different portion of the light shield apparatus;

FIG. 10 is an elevation of the light shield apparatus of FIG. 1 in combination with an electronics structure located in the receiving space;

FIG. 11 is a plan of the light shield apparatus and electronics structure of FIG. 2 showing the thermal expansion pathway of the light shield;

FIG. 12 is an elevation of a light shield apparatus in combination with an electronics structure in accordance with another aspect of the present disclosure;

FIG. 13 is an elevation of a light shield apparatus in combination with an electronics structure in accordance with another aspect of the present disclosure;

FIG. 14 is an elevation of a compound light shield apparatus in combination with a plurality of electronics structures in accordance with another aspect of the present disclosure;

FIG. 15A is a plan of a light shield apparatus in combination with an electronics structure showing the thermal expansion pathway of the light shield in accordance with another aspect of the present disclosure;

FIG. 15B is a plan of a light shield apparatus in combination with an electronics structure showing the thermal expansion pathway of the light shield in accordance with another aspect of the present disclosure;

FIG. 16 is a plan of a light shield apparatus in combination with an electronics structure showing the thermal expansion pathway of the light shield in accordance with another aspect of the present disclosure;

FIG. 17 is a plan of a light shield apparatus in combination with an electronics structure showing the thermal expansion pathway of the light shield in accordance with another aspect of the present disclosure;

FIG. 18 is a plan of a light shield apparatus in a plan of a light shield apparatus in combination with an electronics structure showing the thermal expansion of the light shield in accordance with another aspect of the present disclosure;

FIG. 19 is an elevation of the light shield apparatus and electronics structure of FIG. 18;

FIG. 20 is a flattened view of the light shield thereof; and

FIG. 21 is a plan of a light shield in accordance with another aspect of the present disclosure.

Corresponding reference characters indicate corresponding parts throughout the drawings.

### DETAILED DESCRIPTION

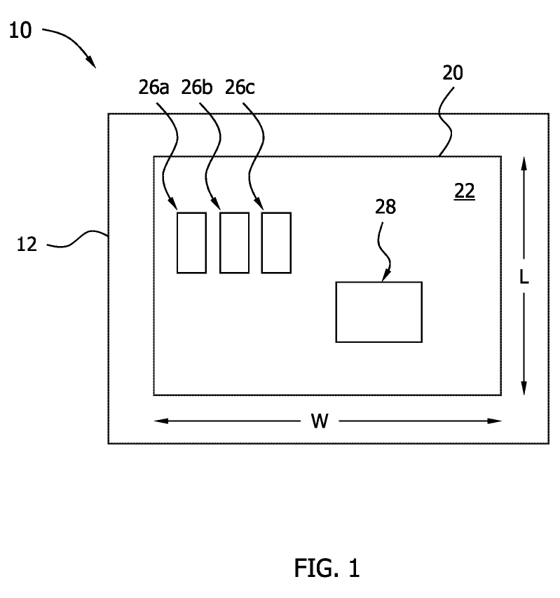

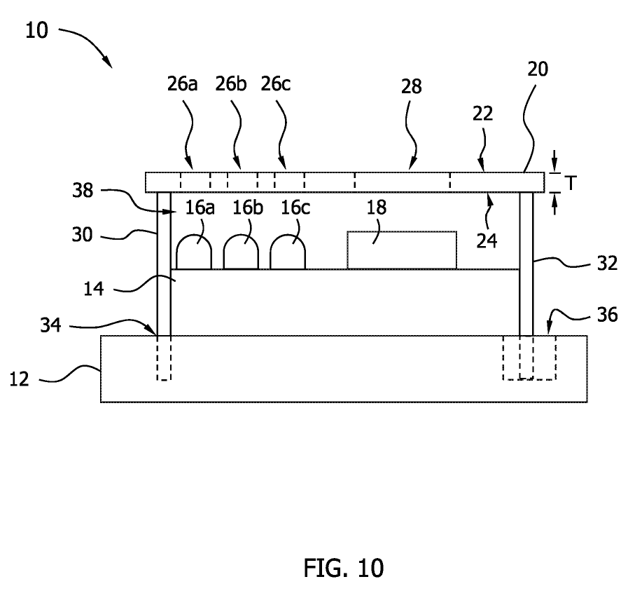

Referring to FIG. 1, a light shield assembly in accordance with one aspect of the present disclosure is shown generally with reference number 10. The light shield assembly 10 includes a base support 12 (broadly, a support) and a light shield 20 located above the base support 12. As best shown in FIG. 10 and described in greater detail below, one or more support elements, such as columns, pins, tabs, or other structures, may be used to couple the light shield 20 to the base support 12 and to create space between the light shield 20 and base support 12 to receive one or more electronics structures to allow for light shielding in accordance with the principles described herein. It will be appreciated that such support elements may be configured to provide compensation mechanisms for thermal expansion of the light shield in accordance with the features described herein below.

Referring still to FIG. 1, the light shield 20 has a body that defines a first (e.g., front or upper) surface 22. As further shown in FIG. 10, the body of light shield 20 defines a second (e.g., rear or lower) surface 24 opposite the first surface 22, and a thickness T of the body extends between the first surface 22 and the second surface 24. Returning to FIG. 1, the body of light shield 20 has a length L and a width W that are significantly greater than the thickness T.

In general, the light shield 20 is configured to at least partially overlie electronics structures positioned on the base support 12. The light shield 20 includes a predetermined arrangement of openings (broadly, each an illumination passage, and one or more passages forming illuminating passaging), such as openings extend through the light shield 20 from the first surface 22 to the second surface 24, to allow light to travel to designated areas of one or more electronics structures located between the light shield 20 and the base support 12 for targeted processing while the remainder of the body of light shield 20 blocks (broadly, obstructs) the processing light to protect thermally sensitive regions of the one or more electronics structures. In the present example, three small, rectangular openings 26a, 26b, 26c are oriented near the upper left of the body, and one larger, rectangular opening 28 is oriented near the lower right of the body. It will be appreciated that the quantity, shape, position, size, and orientation of openings may vary depending on where exposure to light is desired. Additionally, it will be appreciated that the layout of electronics structures may be designed to match desired masking patterns, e.g., by concentrating openings near a center of thermal expansion of a corresponding light shield. Further details about centers of thermal expansion are described herein.

The base support 12 generally comprises a rigid, thermally stable material, such as glass, quartz, polymers, semiconductor substrates, metals, or other suitable materials. The light shield 20 may comprise a variety of materials exhibiting various properties including low optical absorptivity, high thermal conductivity, high temperature resistance, high specific thermal mass, and/or low coefficients of thermal expansion. For example, metals or metal alloys such as aluminum and nickel-plated copper having a thickness on the order of millimeters may remain dimensionally stable during contemplated processing operations. Of course, other materials may be used without departing from the scope of the present disclosure.

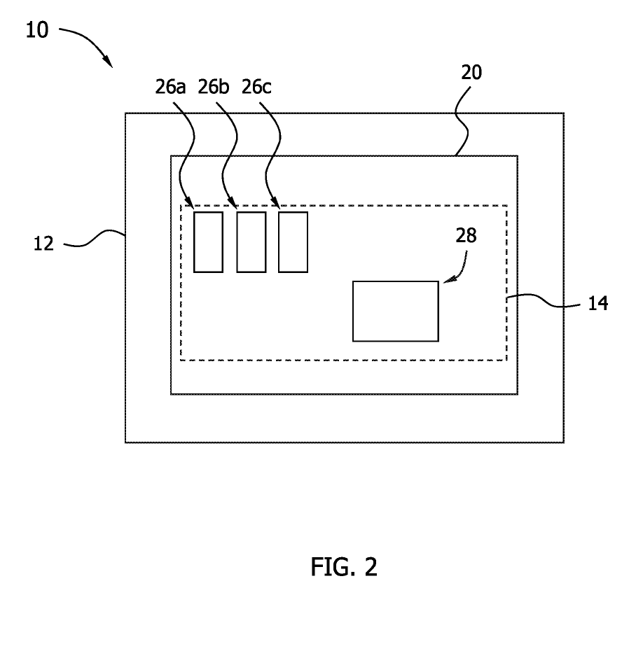

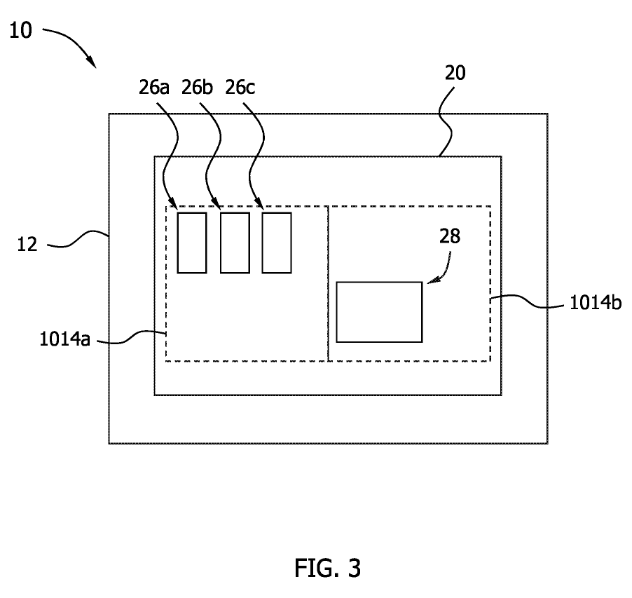

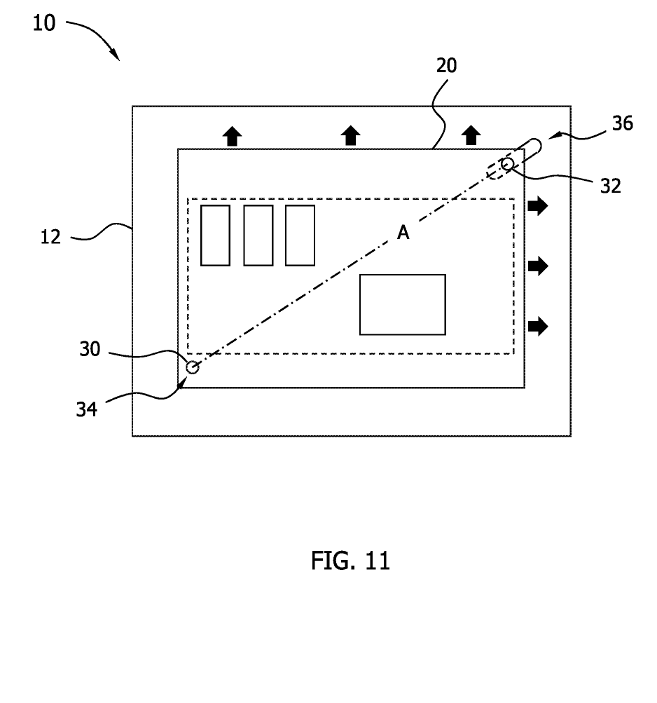

Referring now to FIG. 2, the light shield assembly 10 may receive one electronics structure 14 (shown in broken lines) between the light shield 20 and the base support 12. It will be appreciated that the electronics structure 14 may be aligned precisely relative to the light shield 20 to ensure consistent, targeted processing relative to the openings 26a, 26b, 26c, and 28. Additionally, the light shield assembly 10 is configured to guide the light shield 20 on a thermal expansion pathway that facilitates sustained alignment of the light shield relative to the electronics structure 14 (e.g., certain components thereof to be processed) when the light shield 20 thermally expands, further details of which are described below in connection with FIG. 11. As shown in FIG. 3, the light shield assembly 10 may alternatively receive a plurality of (e.g., at least two) electronics structures, such as first electronics structure 1014a and second electronics structure 1014b, or a compound electronics structure comprising multiple conjoined components configured to be separated after being processed. In the present example, the first electronics structure 1014a comprises components to be aligned with the openings 26a, 26b, and 26c of the light shield 20, and the second electronics structure 1014b comprises one or more components to be aligned with the opening 28. It will be appreciated that the structures and principles described herein are generally applicable regardless of the quantity, shape, or arrangement of electronics structures being processed using a light shield assembly as contemplated in the present disclosure. Configuration, features, aspects, and method steps described herein with respect to certain examples or embodiments are generally applicable to other examples or embodiments unless stated otherwise.

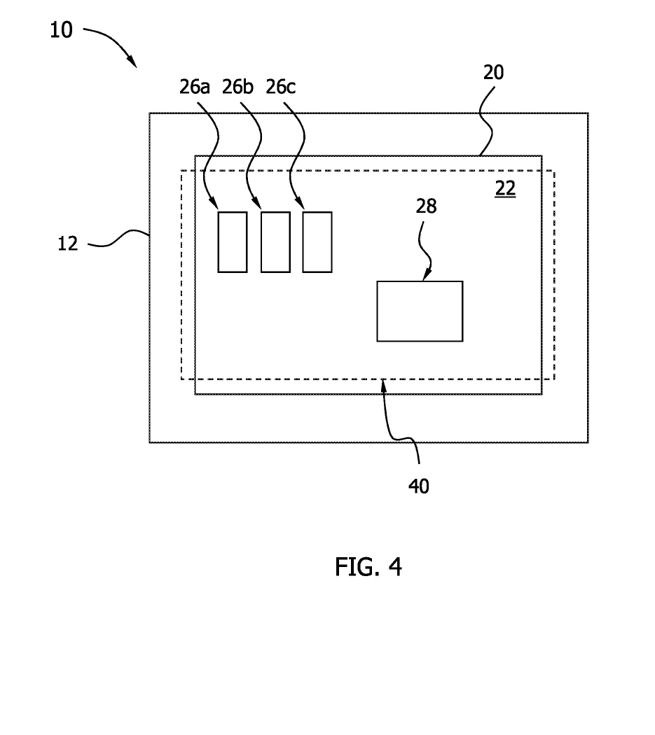

As shown in FIG. 4, it is contemplated that the light shield assembly 10 can be exposed to one or more pulses of light from a light source that emits light having an illumination area 40 that is approximately equal to the light shield 20 and is greater than the overall area occupied by the openings 26a, 26b, 26c, and 28. In this configuration, it will be appreciated that light is absorbed by the light shield 20 approximately uniformly across the first surface 22, resulting in a relatively uniform thermal expansion profile of the light shield 20.

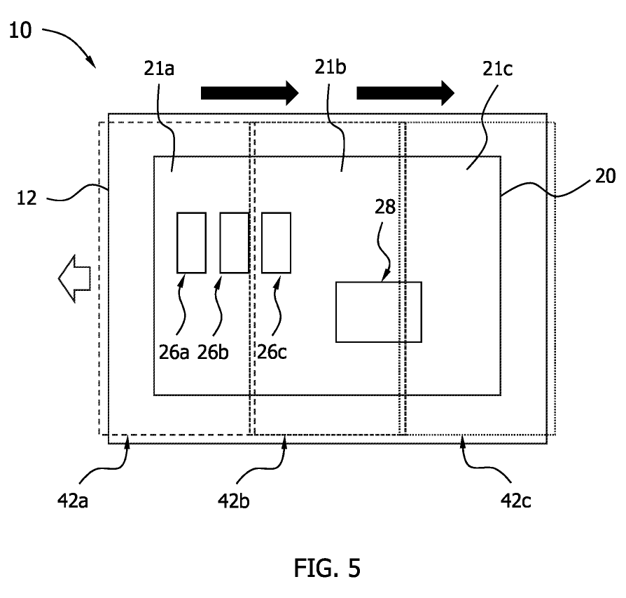

By contrast, in FIG. 5, the light shield assembly 10 is exposed to a sequence of pulses. In particular, the light shield assembly 10 may be moved relative to the light source (e.g., using a conveyor, not shown), as indicated by the left-facing arrow, to expose discrete portions of the light shield 20 to corresponding pulses of light. In the present example, a first portion 21a of the light shield 20 is exposed to light having an illumination area 42a, as indicated in regular dashed lines. The light shield assembly 10 is then moved relative to the light source to expose a second portion 21b of the light shield 20 to light having an illumination area 42b, as indicated in small dashed lines. The light shield assembly is them moved relative to the light source to expose a third portion 21c of the light shield 20 to light having an illumination area 42c. It will be appreciated that all three illumination areas are used to process underlying components aligned with one or more of the four openings 26a, 26b, 26c, 28, and there may be conductive heat transfer through the body of the light shield 20 associated with each successive light pulse, as indicated schematically in black arrows, which can result in non-uniformities in the thermal expansion profile of the light shield 20 during a complete processing cycle (e.g., comprising pulses of light across all three illumination areas 42a, 42b, 42c). As discussed below in connection with FIGS. 10-21, several structural features and movement mechanisms may be employed to accommodate complex thermal expansion profiles in accordance with various aspects of the present disclosure. Although such structural features and movement mechanisms are described as discrete examples herein, it is contemplated that such features and mechanisms can be adjusted, modified, and combined without departing from the scope of the present disclosure.

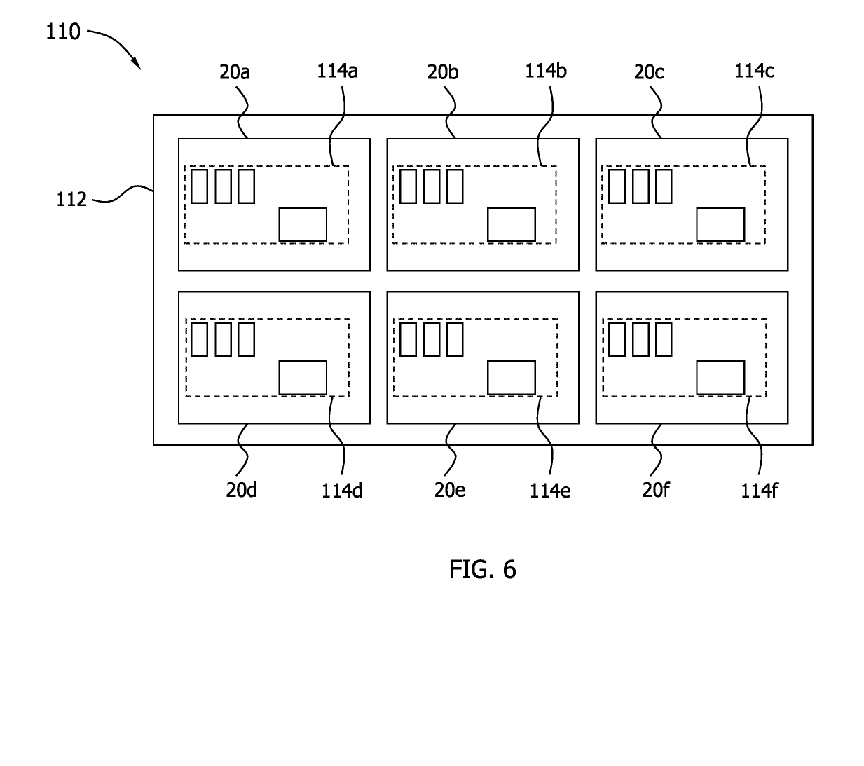

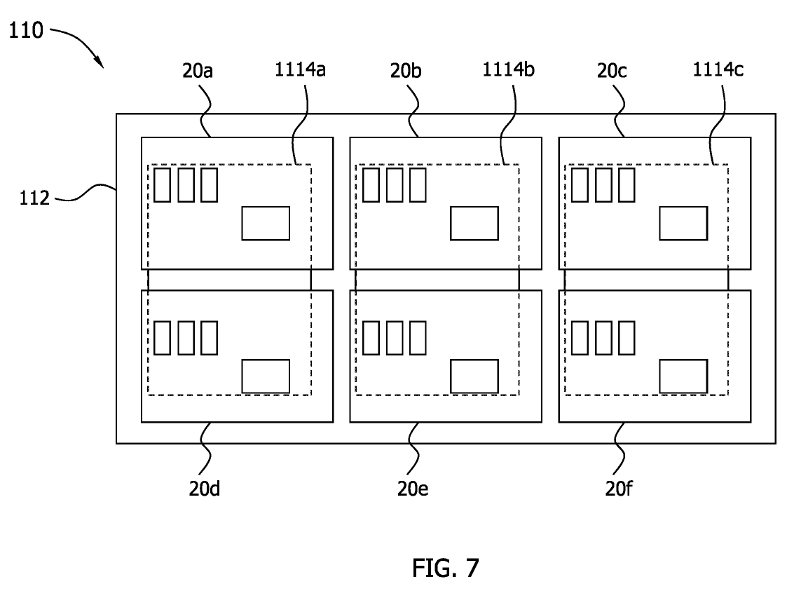

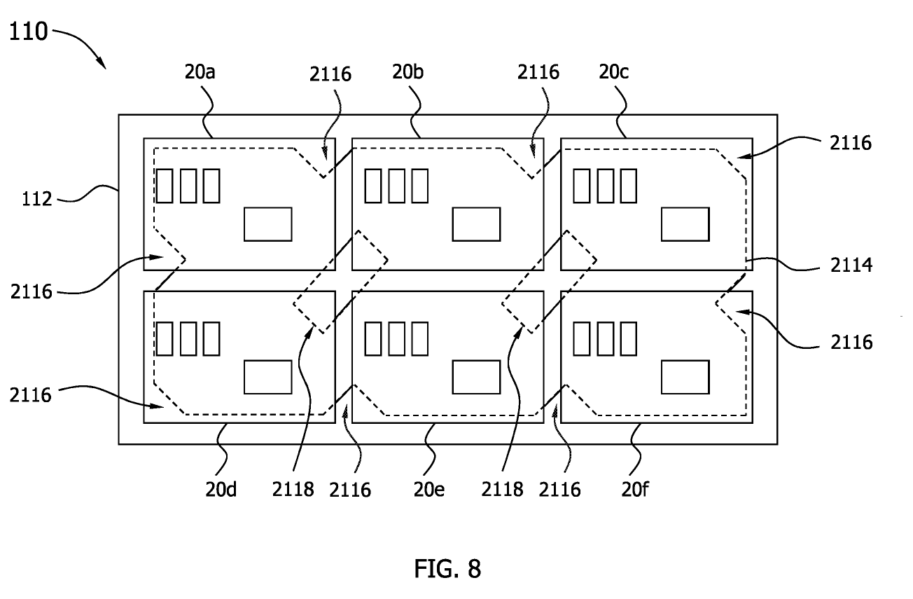

Referring now to FIGS. 6-8, a compound light shield assembly in accordance with another aspect of the present disclosure is shown generally using reference number 110. The light shield assembly 110 includes a base support 112 and is configured to support a plurality of light shields 20 (e.g., six light shields 20a-20f) and either a plurality of electronics structures 114 (e.g., six electronics structures 114a-114f, as best shown in FIG. 6, or three electronics structures 1114a-1114c, as best shown in FIG. 7) or a single electronics structure 2114 (as best shown in FIG. 8). The light shield assembly 110 is configured to support the light shields 20a-20f in a grid pattern or array, though it will be appreciated that other arrangements may be suitable in alternative light shield assemblies depending on various characteristics such as the shape or thermal expansion characteristics of the base supports, light shields, and electronics structures used with such alternative assemblies.

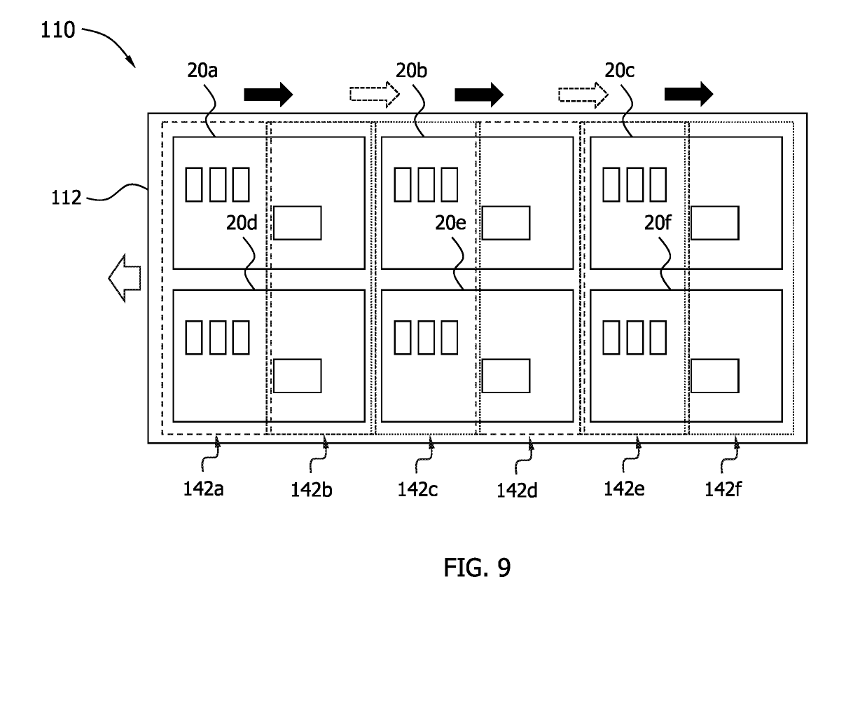

In the present example, the light shields 20a-20f are spaced apart relative to one another, e.g., by a distance of at least 500 microns and more preferably at least 1 mm and are movable relative to one another. It will be appreciated that having individual light shields spaced apart in this manner provides several advantages, including but not limited to the following. First, the spacing between light shields limits the thermal expansion of each light shield to a smaller area as compared to a larger, monolithic light shield covering a greater area, resulting in reductions in thermal expansion of regions farther away from anchor points or other centers of thermal expansion (examples of which are described below in greater detail). Relatedly, in situations where the angular orientation of light shields deviates due to thermal expansion, the impact of angular displacement is reduced when thermal expansion is distributed about smaller, localized areas as compared to a larger, monolithic light shield covering a greater area. Second, the spacing between light shields provides natural thermal breaks in the light shield assembly to reduce the impact of conductive heat transfer through the entire light shield assembly during sequences of processing pulses, further details of which are described below in connection with FIG. 9. Third, the segmented light shield configuration allows for selective placement and removal of individual light shields for maintenance and/or replacement while maintaining the centering and thermal breaking functionality discussed above.

Referring again to FIG. 6, it will be appreciated that the light shield assembly 110 can be configured to accommodate a plurality of light shields 20 that at least partially overlie a corresponding plurality of electronics structures 114 in alignment in respective zones of the light shield assembly 110, as designated by the letters a through f in the drawings. As shown schematically in FIG. 9, when the light shield assembly 110 is exposed to a sequence of six illumination areas 142a-142f (e.g., each including one or more pulses) in a traveling direction (e.g., left relative to the light source, as shown with a solid white arrow), although some heat is generated and subsequently transferred to later parts of each respective light shield, as indicated in black arrows above respective columns of light shields, the heat transfer pattern is generally terminated at the end of each light shield, as indicated in dashed white arrows. In this manner, the same general heating pattern can be repeated in each successive column of light shields and electronics structures, creating consistency in light shield performance when batches of electronics structures are processed on a single carrier. Therefore, by coordinating the light exposure patterns relative to the placement and geometry of individual light shields 20a-20f, repeatable, batch-based, masked processing can be conducted with improvements in performance and batch consistency compared to a batch assemblies in which a large, monolithic light shield is used. It will be appreciated that similar principles can apply in the case of the configuration shown in FIG. 7, in which electronics structures 1114a, 1114b, and 1114c are arranged in columns corresponding to respective groupings of light shields 20a/20d, 20b/20e, and 20c/20f.

Referring again to FIG. 8, a single electronics structure 2114 may be supported by the light shield assembly 110 in another alternative configuration. It will be appreciated that, due to the grid arrangement of the light shields 20a-20f, side openings 2116 and center openings 2118 (e.g., recesses, holes, etc.) may be formed in particular regions of the electronics structures to accommodate support structure (e.g., extending from the base support to the shielding) for holding each light shield in a suitable position for operation. It will be appreciated that such openings and supports may have a built-in alignment function for the electronics structure 2114 and the light shields 20a-20f in addition to the general advantages of the segmented design discussed above. Several examples of support structures are described in greater detail below in connection with FIGS. 10-17. Openings in the electronics structure facilitate passage of such support structures for coupling of the base support and shielding without interference by the electronics structure. For example, the electronics structure may comprise a plurality of electronics structure segments or portions (e.g., repeated segments or portions) each underlying an associated shield segment 20a-20f, and the electronics structure segments or portions may be separated from each other after thermal processing. Referring further to FIG. 9, it will be appreciated that the advantages of the segmentation of the light shields 20a-20f discussed above can apply when an electronics structure spanning several exposure widths is used with the light shield assembly, e.g., due to the localization of thermal expansion in comparatively small regions, allowing for more precise shaping with reductions in large-scale warpage and/or buckling of larger-scale light shields.

Now with reference to FIGS. 10 and 11, an example of a support and movement mechanism for the light shield assembly 10 is shown. In the present example, the light shield 20 is supported by a first support pin 30 and a second support pin 32 (broadly, support columns) on opposing corners of the body of the light shield 20. It will be appreciated that receiving holes extend through the thickness T of the body of light shield 20 to secure each respective support pin 30, 32 to the light shield. Other configurations (e.g., columns extending upward from the base and/or electronics structure(s)) can be used without departing from the present disclosure. As can further be seen in FIG. 10, the electronics structure 14 can be positioned between the light shield 20 and the base support 12 and suitably aligned with the light shield 20 without interference from the support pins 30, 32. For example, a first electronic component 16aof the electronics structure 14 can be in registration with corresponding opening 26a; a second electronic component 16b can likewise be in registration with corresponding opening 26b; a third electronic component 16c can be in registration with corresponding opening 26c, and a fourth electronic component 18 can be in registration with corresponding opening 28. It will be appreciated that suitable support columns provide vertical clearance for compatible electronics structures by defining a receiving space 38 between the second surface 24 of the body of light shield 20 and the base support 12.

Referring still to FIGS. 10 and 11, the base support 12 is fitted with a receiving hole 34 and a receiving slot 36 (broadly, guide) corresponding to the respective positions of the first support pin 30 and second support pin 32 relative to the light shield 20 to allow the light shield 20 to stand above the base support 12 in a manner that permits thermal expansion along a predetermined thermal expansion pathway defined by the receiving hole 34 and receiving slot 36. In the present example, the receiving slot 36 has an elongated, obround shape defined by a circumferential side wall. The receiving slot 36 is substantially aligned with receiving hole 34 along a thermal expansion axis A associated with the thermal expansion profile of light shield 20. It will be appreciated that the pin-in-hole and pin-in-slot arrangements can be referred to broadly as an expansion mechanism. In the present example, it is contemplated that the light shield 20 may experience non-uniform thermal expansion in different portions of the light shield body. The thermal expansion axis A is selected to provide substantially uniform travel of the light shield 20 outward from the location of receiving hole 34 when thermal expansion occurs in the light shield in lengthwise and widthwise directions (as defined in connection with FIG. 1). In particular, the side wall of the receiving slot 36 contacts a lower end of the second support pin 32 to constrain the angular travel of the light shield 20 while the body expands generally outward during thermal expansion, as indicated by the black arrows shown in FIG. 11. The constraints provided by the receiving slot 36 therefore facilitate alignment of the light shield 20 during thermal expansion while permitting some freedom to expand without causing significant warpage or buckling. Other configurations of expansion mechanisms can be used without departing from the scope of the present disclosure.

Although the receiving slot 36 is located in the base support 12 in the present example, it will be appreciated that a receiving slot could alternatively be located in the light shield 20 to define a similar thermal expansion pathway without departing from the scope of the present disclosure. Moreover, although the thermal expansion phenomena are described above in the context of a light shield assembly comprising a single light shield, it will be appreciated that the same principles can be applied with respect to individual light shields in a compound light shield assembly such as the light shield assembly 110 described above in connection with FIGS. 6-9. Accordingly, in addition to the general advantages associated with light shield segmentation described above, it will be appreciated that the advantages of constrained motion associated with the pin-and-slot mechanism described herein can be applied to multiple light shields simultaneously for additional degrees of consistency and precision in batch-based processing operations.

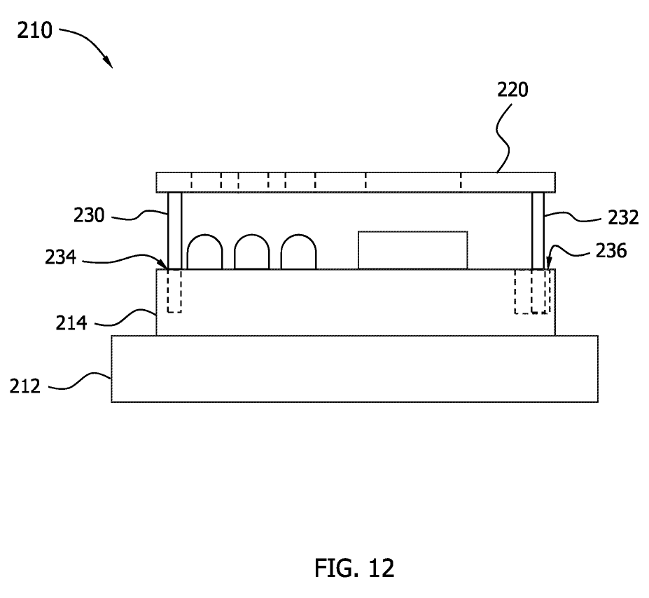

Now referring to FIG. 12, in another configuration, one or more electronics structures can be configured to support a corresponding one or more light shields rather than the base support (which may be omitted). In the example shown in FIG. 12, a light shield assembly 210 includes a base support 212, an electronics structure 214, and a light shield 220 supported by the electronics structure 214 via a first support pin 230 and a second support pin 232 (broadly, support columns). In the present example, the first support pin 232 is configured to be securely received in a receiving hole 234 formed in the electronics structure 214, and the second support pin 232 is configured to be securely received in a receiving slot 236 formed in the electronics structure 214. The functionality of the light shield assembly 210 is substantially the same as the light shield assembly 10 as described above in connection with FIGS. 10-11, in which the travel of the light shield 220 due to thermal expansion is constrained along an axis corresponding to the relative positions of the first support pin 230, the second support pin 232, and the shape of the receiving slot 236. It will be appreciated that multiple light shields may be installed on one electronics structure or on a plurality of electronics structures to provide a complex light shield assembly in accordance with the examples described above.

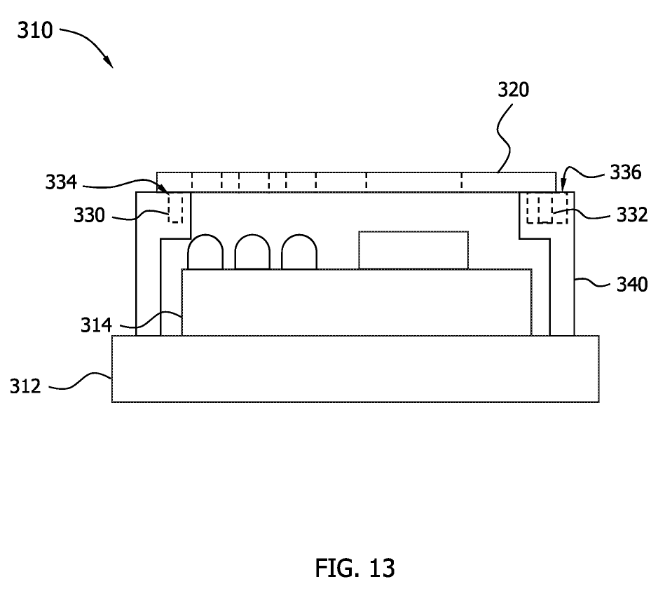

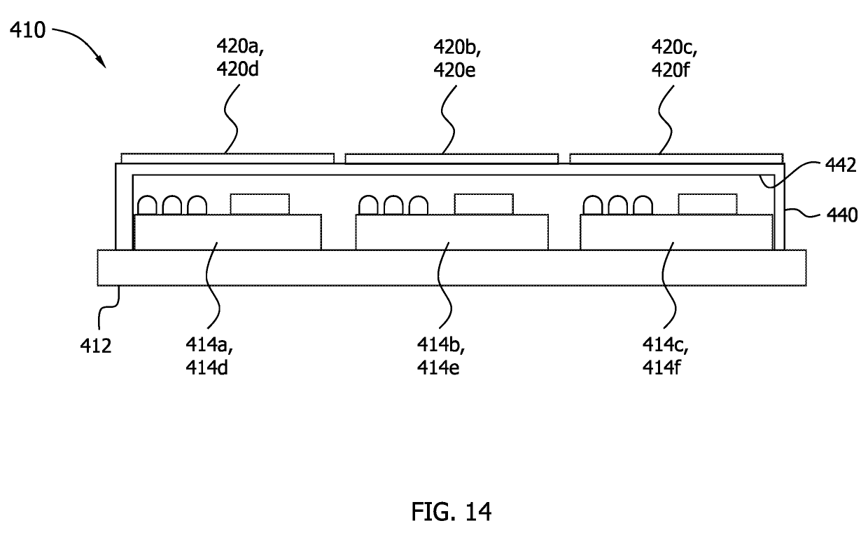

Now referring to FIGS. 13 and 14, in another aspect, light shield carrier structures (e.g., frames) can be used to provide additional modularity in light shield structures so that one or more light shields or light shield segments (broadly, a light shield assembly) can be more easily aligned, installed, and uninstalled relative to a corresponding support base and one or more corresponding electronics structures. As shown in FIG. 13, one example of such a light shield assembly 310 includes a support base 312, a light shield 320, and a light shield carrier 340 configured to support the light shield 320 above the support base 312 with space to accommodate an electronics structure 314. The light shield 320 is configured to receive a first alignment pin 330 and a second alignment pin 332 that provide alignment functionality relative to the light shield carrier 340 that is analogous to the functionality of corresponding pins 30, 32 of the light shield assembly 10 as described above in connection with FIGS. 10-11. However, it will be appreciated that the first alignment pin 330 and the second alignment pin 332 are not configured to provide vertical support to the light shield 320. The light shield carrier 340 includes a receiving hole 334 configured to receive the first alignment pin 330 and a receiving slot 336 configured to receive the second alignment pin 332 and provide similar movement functionality as the examples described above in connection with FIGS. 10-11 and 12.

Now referring to FIG. 14, it will be appreciated that light shield carriers can be adapted for use in complex light shield assemblies to provide a support and alignment structure for multiple light shields that can be removably installed on an underlying base support for numerous advantages, including accessibility, modularity, and repairability. As shown in FIG. 14, an example of a complex light shield assembly 410 includes a broad support base 412 configured to support six electronics structures 414a-414f in a grid pattern similar to the example described above in connection with FIG. 6. Likewise, the light shield assembly 410 includes six light shields or light shield segments 420a-420f (e.g., light shield assembly) arranged in a corresponding grid pattern or array. All six light shields 420B-420f are supported by a light shield carrier structure 440 that includes a support frame 442 configured to support each individual light shield 420 and incorporate the functional features of the alignment pins 330, 332, receiving hole 334, and receiving slot 336 discussed above in connection with the single-light-shield example of FIG. 13. It will further be appreciated that the support frame 442 defines openings that allow for unobstructed passage of light through corresponding openings in each respective light shield 420a-420f supported by the light shield carrier structure 440. In the present example, it will be appreciated that the light shields 420a-420f can be aligned on the light shield carrier 440 independently of the alignment of the electronics structures 414a-414f on the support base 412. In a single installation step, the entire light shield carrier 440 that supports the light shields 420a-420f can be moved into registration with and coupled to the support base 412, thereby moving the carrier into position with respect to the electronics structures. Although the present example is described in connection with the placement and alignment of six independent electronics structures, it will be appreciated that the same structure can be used for enhanced alignment and ease of use even when larger electronics structures (e.g., a single electronics structure positioned beneath the light shields 420a-420f) are used.

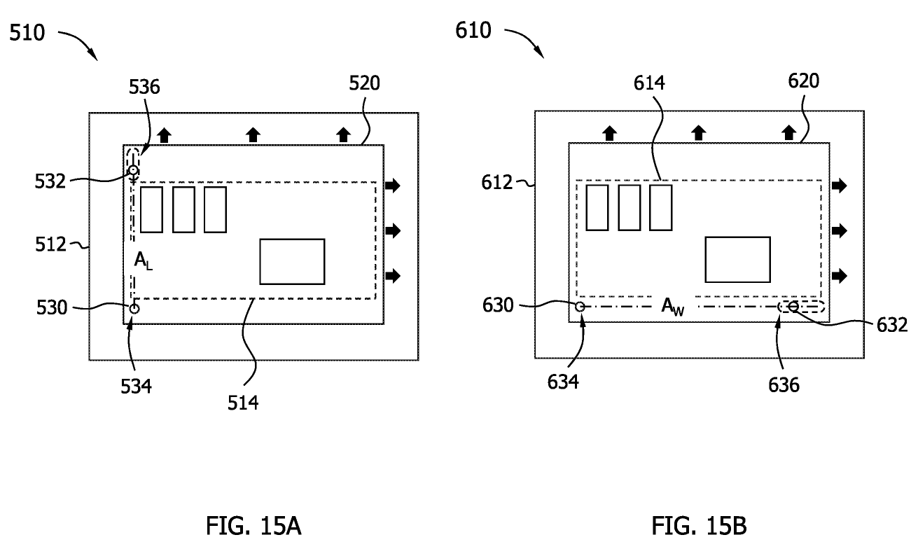

Now with reference to FIGS. 15A, 15B, 16, and 17, in further aspects, the thermal expansion pathway associated with a corresponding light shield assembly can be further altered based on a variety of factors. As shown in FIG. 15A, a light shield assembly 510 is provided with a substantially lengthwise travel path for a corresponding support pin 532. In this example, the light shield assembly 510 includes a base support 512 and a light shield 520. The light shield 520 is operatively connected to a first support pin 530 and a second support pin 532 in substantially the same manner as the light shield 20 is connected to respective support pins 30, 32, as described above in connection with FIGS. 10-11. The base support 512 includes a receiving hole 534 and a receiving slot 536 to define a substantially lengthwise travel path defined by a lengthwise axis A_{L} extending between the receiving slot 536 and receiving hole 534. In this example, the lengthwise axis A_{L} is not oriented in the overall direction of thermal expansion of the light shield 520 but nonetheless permits thermal expansion of the light shield outward from the location of the first support pin 530 generally in the overall direction of thermal expansion.

As shown FIG. 15B, an analogous light shield assembly 610 is provided with a substantially widthwise travel path for a corresponding support pin 632. In this example, the light shield assembly 610 includes a base support 612 and a light shield 620. The light shield 620 is operatively connected to a first support pin 630 and a second support pin 632 in substantially the same manner as the light shield 20 is connected to respective support pins 30, 32, as described above in connection with FIGS. 10-11. The base support 612 includes a receiving hole 634 and a receiving slot 636 to define a substantially lengthwise travel path defined by a widthwise axis Aw extending between the receiving slot 636 and receiving hole 634. In this example, the widthwise axis Awis not oriented in the overall direction of thermal expansion of the light shield 620 but nonetheless permits thermal expansion of the light shield outward from the location of the first support pin 630 generally in the overall direction of thermal expansion. It will be appreciated that the design features and corresponding functions described above in connection with FIGS. 15A and 15B can be applied to or combined with the features of a variety of light shield assemblies, including the various examples described herein.

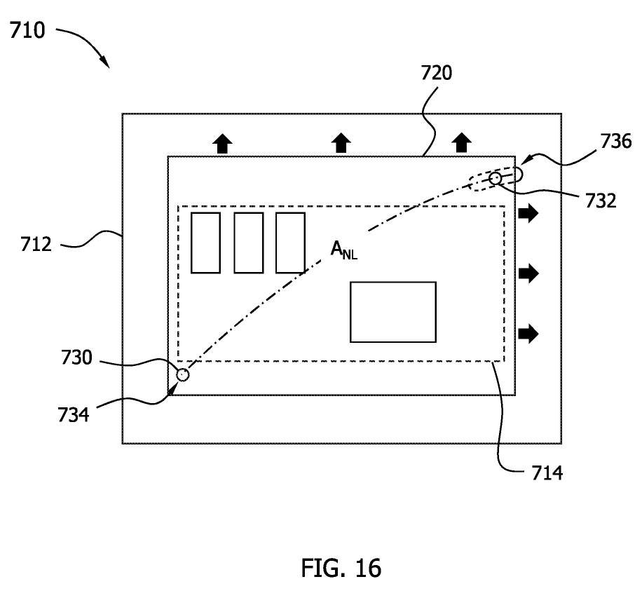

Now referring to FIG. 16, a configuration is shown in which the thermal expansion pathway associated with a light shield assembly is modified to follow a nonlinear path, e.g., as a corrective measure for irregular thermal expansion characteristics in a corresponding light shield. For example, in FIG. 16, a light shield assembly 710 is configured to guide a respective light shield 720 along a nonlinear thermal expansion pathway defined by a nonlinear (e.g., elliptical) axis A_{NL}. In this example, the light shield assembly 710 includes a base support 712 and a light shield 720. The light shield 720 is operatively connected to a first support pin 730 and a second support pin 732 in substantially the same manner as the light shield 20 is connected to respective support pins 30, 32, as described above in connection with FIGS. 10-11. The base support 712 includes a receiving hole 734 and a receiving slot 736 to define a substantially lengthwise travel path defined by a nonlinear axis A_{NL} extending between the receiving slot 736 and receiving hole 734. In this example, the nonlinear axis A_{NL} is defined by an elliptical path that extends from the center of the receiving slot 736 through the center of the receiving hole 734. It will be appreciated that the design features and corresponding functions described above in connection with the light shield assembly 710 of FIG. 16 can be applied to or combined with the features of a variety of light shield assemblies, including the various examples described herein. Furthermore, although the nonlinear path of the light shield assembly 710 is elliptical in the present example, it will be appreciated that other nonlinear paths (e.g., parabolic, discontinuous angles, etc.) may be employed without departing from the scope of the present disclosure.

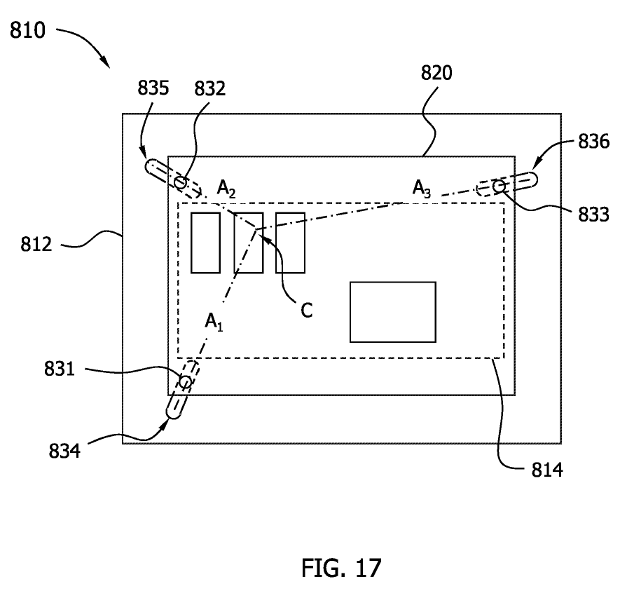

In a further aspect, a light shield assembly can be modified to be defined by a plurality of (e.g., at least two) pin-and-slot interfaces to provide positional centering relative to a predetermined center of thermal expansion located away from an anchor point (such as the receiving holes 34, 234, 334, 534, 634, and 734 discussed above in connection with their respective light shield assemblies). For example, a light shield assembly in accordance with this concept of positional centering relative to a predetermined center of thermal expansion is shown generally with reference number 810 in FIG. 17. In the light shield assembly 810, thermal expansion is configured to be rooted in a predetermined center point C (or centroid), further details of which are described herein. The light shield assembly 810 includes a base support 812 and a light shield 820 configured to be supported above the base support 812 to define a receiving space in which a light shield 814 (broadly, at least one light shield) can be placed for thermal processing in accordance with the processes described herein.

In the present example, the light shield 820 is operatively connected to a first alignment pin 831, a second alignment pin 832, and a third alignment pin 833 similar to the two-pin connections described herein above. In the present example, each respective alignment pin 831, 832, 833 is configured to slidingly engage a corresponding slot 834, 835, 836 such that the side walls of each slot constrain the linear movement of the light shield 820 while providing some rotational freedom. As can be seen in FIG. 17, each of the slots 834, 835, 836 is oriented along a corresponding slot axis A₁, A₂, A₃ that intersects with the predetermined center point C. In this configuration, the slots control the relative motion of the alignment pins 831, 832, 833 to orient the center of thermal expansion at the predetermined center point C. The position and orientation of the slots can vary depending on numerous factors, including the geometry of electronics structures to be processed beneath each respective light shield, the geometry of the light shield and/or openings in the light shield, and proximity to the desired center point for thermal expansion. It will be appreciated that acceptable configurations will result in constrained motion, while some unstable configurations, such as two parallel slots (with no further constraints), would be avoided. Moreover, it will be appreciated that additional degrees of freedom in travel may be achieved when more slots (e.g., three or more slots) with intersecting axes are provided compared to configurations with only two constraining slots. It will be appreciated that the features of the light shield assembly 810 can be applied to or combined with the features of a variety of light shield assemblies, including the various examples described herein.

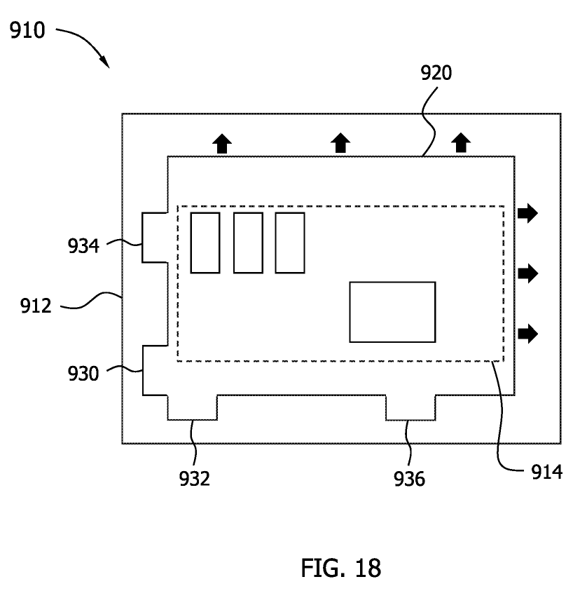

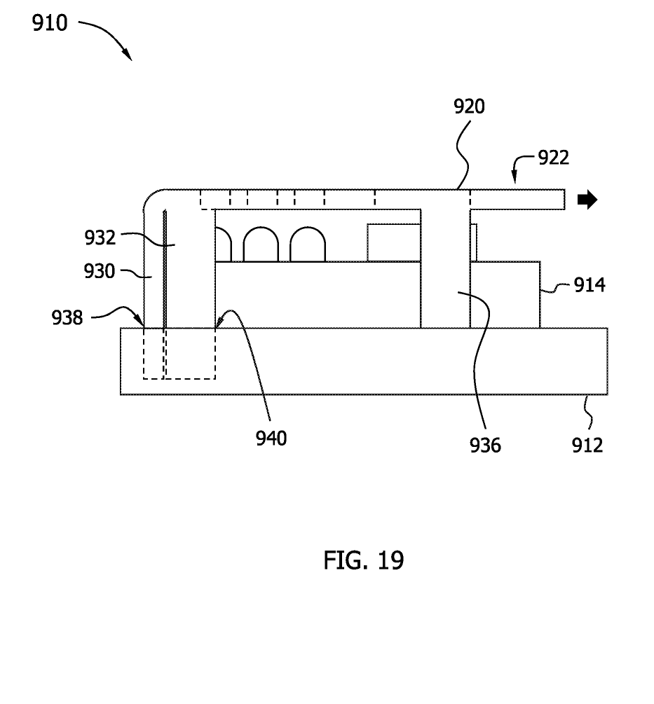

Now with reference to FIGS. 18 and 19, a light shield assembly in accordance with a further aspect of the present disclosure is shown generally using reference number 910. The light shield assembly 910 includes a base support 912 and a light shield 920 (e.g., a light shield member) configured to be supported by the base support 912 to cover an aligned electronics structure 914 (broadly at least one electronics structure). The light shield 920 includes four support appendages: a first anchoring leg 930, a second anchoring leg 932, a first mobile leg 934, and a second mobile leg 936 (broadly, a plurality of folded legs, folds, flaps, tabs, etc.). In the present example, the first and second anchoring legs 930, 932 are configured to be securely received in corresponding receptacles in the base support 912 to anchor the light shield 920 to the base support 912. In the present example, the first and second anchoring legs 930, 932 are located around the lower left corner of the electronics structure 914, resulting in a center of thermal expansion around the lower left corner of the electronics structure 914. However, it will be appreciated that the first and second anchoring legs 930, 932 can be oriented in different locations without departing from the scope of the present disclosure, and their respective locations can be selected to match a predetermined center of thermal expansion similar to the configuration of the light shield assembly 810 discussed above in connection with FIG. 17. The first and second mobile legs 934, 936 are configured to slidably contact an upper surface of the base support 912 to provide additional support to the light shield 920. Although the first and second mobile legs 934, 936 are shown extending from the same respective sides of the light shield 920 as the first and second anchoring legs 930, 932, mobile legs can be positioned to extend from different sides and in different locations without departing from the scope of the present disclosure. As indicated in FIGS. 18 and 19 using black arrows, the light shield 920 is free to expand (thermally) outward from the center of thermal expansion associated therewith.

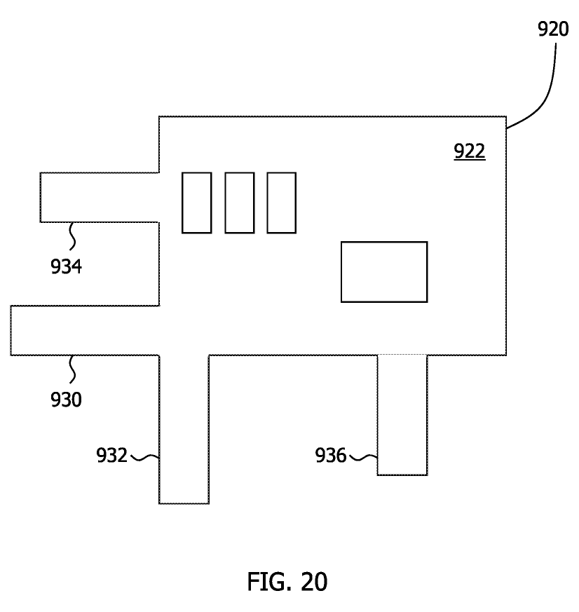

As can further be seen in FIG. 20, the light shield 920 can be formed from a flat sheet, such as an aluminum sheet. In this example, it will be appreciated that the first and second anchoring legs 930, 932 and the first and second mobile legs 934, 936 are folded approximately 90 degrees (e.g., substantially perpendicular) relative to a primary surface 922 of the light shield 920 to provide vertical support when the light shield 920 is supported by the base support 912. Due to the interaction of the first and second anchoring legs 930, 932 with receptacles in the base support 912, it will be appreciated that the first and second anchoring legs 930, 932 extend a greater distance outward in their respective corresponding directions than the first and second mobile legs 934, 936. However, in alternative assemblies, alternative supporting structures (e.g., receiving elements protruding from the base support 912) could be used such that the first and second anchoring legs 930, 932 could extend the same distance or a shorter distance than the first and second mobile legs 934, 936 without departing from the scope of the present disclosure. It will be appreciated that the configuration of the light shield assembly 910 and light shield 920 can be used in a light shield assembly in which a plurality of light shields are supported by one base support, similar to the examples described above in connection with FIGS. 6-9.

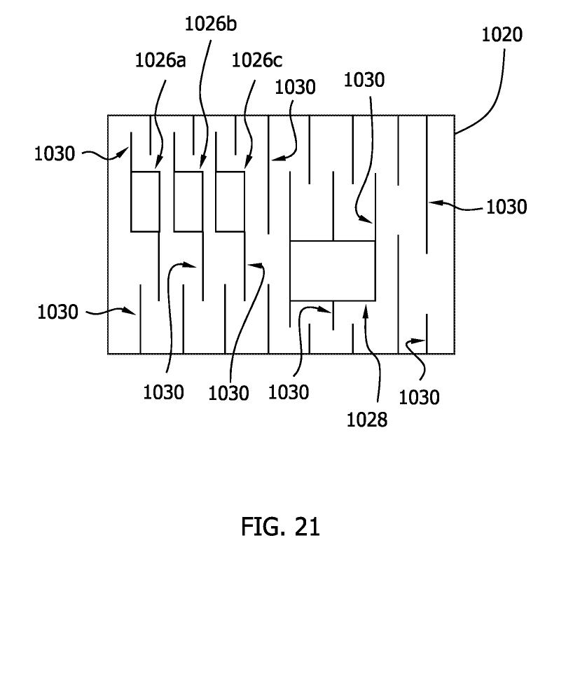

Now with reference to FIG. 21, a light shield in accordance with another aspect of the present disclosure is shown generally using reference number 1020. It will be appreciated that the characteristics of the light shield 1020 described herein are broadly applicable with respect to any of the preceding examples of light shield assemblies without departing from the scope of the present disclosure. In the present example, the light shield 1020 comprises a body having a length, width, and thickness in accordance with the length, width, and thickness of the light shield 20 discussed herein above. Additionally, the light shield 1020 includes four openings 1026a, 1026b, 1026c, and 1028 that generally correspond to respective counterparts 26a, 26b, 26c, and 28 of the light shield 20. In addition to the openings, the light shield 1020 includes a plurality of lengthwise cuts 1030 (broadly, thermal breaks or thermal boundary lines) that extend at least partially through (e.g., entirely through) the thickness of the light shield 1020 to provide small physical discontinuities over the width of the light shield 1020. The placement of the cuts 1030 impedes conductive heat transfer through the body of the light shield 1020 in one direction (e.g., the widthwise direction) by creating additional thermal resistance in the carrier body by extending the path of heat transfer therethrough. Accordingly, when the light shield is exposed to sequential pulses of light in the corresponding direction, e.g., in accordance with the sequence of pulses described above in connection with FIG. 5, the cuts 1030 can mitigate the thermal gradients experienced by the light shield 1020 in that direction to enhance yield consistency and accuracy during individual electronics structure processing and batch-based electronics structure processing when the light shield is used (or a plurality of the light shields are used).

With respect to any of the examples described above, one or more light shield assemblies (e.g., comprising shields and/or shield segments) (broadly, “shielding”) can be used in conjunction with one or more electronics structures in a method of thermally processing the electronics structure(s) such as to sinter or solder. For example, a light source such as a source of incoherent light (e.g., xenon flashlamp that emits a broadband spectrum of light) may emit one or more pulses of incoherent light or non-collimated light to expose the shielding and portions of the electronics structure(s) to illumination. The illumination may be referred to as photonic processing. The illumination performs a thermal processing of the electronics structure(s) such as sintering or soldering. For example, the electronics structure(s) and/or components thereof may comprise solder that is heated via the one or more pulses of light (through one or more openings in the shielding) to cause the solder to flow. Desirably, the shielding is configured to maintain location of the opening(s) therein in registration with the portions desired to be thermally processed despite thermal expansion of the shielding due to heat from the illumination. For example, any of the configurations or techniques discussed above may be used, including connection structure of shielding to a support and/or thermal break structure. In such processes, an illumination area (e.g., beam area) of the light source may be larger than or smaller than the shielding, a shield, and/or a shield segment. For example, the light source may be moved relative to the electronics structure(s) shielding, or the electronics structure(s)/shielding may be moved relative to the light source, such that one or more pulses of light are used to illuminate multiple successive illumination areas (e.g., overlapping or consecutive areas) that may be applied in a variety of patterns (e.g., linear, serpentine, raster, etc.). Desirably, the shielding and coupling of the shielding to the support and/or electronics structure(s) is configured to maintain registration of openings in the shielding (e.g., illumination passage(s)) with respect to portions or segments of the electronics structure(s) desired to be thermally processed. Any of the shielding (and thermal expansion mechanisms) described above can be used. In one example, a given illumination area is subjected to such light to provide a radiant exposure (or energy density) of at least 20 J/cm². For example, one or more illumination areas (e.g., overlapping illumination areas) may be heated in sequence to apply a radiant exposure of at least 20 J/cm² to the entirety of the portions/segments of the one or more electronics structures to be processed. For example, such radiant exposure may be useful for sintering, soldering, or crosslinking the portions/segments (or components) of the electronics structure(s).

In some examples, the electronics structure(s) comprise multiple (e.g., repeated) electronics structure portions that are thermally processed when part of a single electronic structure (e.g., panel, wafer, chip) and after the thermal processing the electronics structure portions are separated. In such a case, the joined electronics structure portions are convenient for thermal processing together at large scale (high volume) and are separated after thermal processing.

Although above examples are described in context of being used with wide-area incoherent light sources such as flashlamps, it will be appreciated that the concepts described herein can be applied to processing operations using other types of light sources, such as small-area or point sources of light scanned or rastered across a designated area, which may also generate intense heat in localized portions of a light shield.

When introducing elements of the present disclosure or the preferred embodiments(s) thereof, the articles "a", "an", "the" and "said" are intended to mean that there are one or more of the elements. The terms "comprising", "including" and "having" are intended to be inclusive and mean that there may be additional elements other than the listed elements.

In view of the above, it will be seen that the several objects of the present disclosure are achieved and other advantageous results attained.

As various changes could be made in the above constructions and methods without departing from the scope of the present disclosure, it is intended that all matter contained in the above description and shown in the accompanying drawings shall be interpreted as illustrative and not in a limiting sense.

### Other Statements of the Disclosure

As various changes could be made in the above constructions and methods without departing from the scope of the present disclosure, it is intended that all matter contained in the above description and shown in the accompanying drawings shall be interpreted as illustrative and not in a limiting sense.

The following are statements or features of invention described in the present disclosure. Some or all of the following statements may not be currently presented as claims. Nevertheless, the statements are believed to be patentable and may subsequently be presented as claims. Associated methods corresponding to the statements or apparatuses below, and products and apparatuses corresponding to the methods below, are also believed to be patentable and may subsequently be presented as claims. It is understood that the following statements may refer to and be supported by one, more than one, or all the embodiments described above.

A1. A light shield assembly comprising:
a support configured to support at least one electronics structure; and;
at least one light shield comprising a light shield body, the light shield body defining a first face and a second face opposite the first face, the light shield body having a thickness between the first face and the second face, the at least one light shield including illumination passaging;
wherein the second face of each light shield body faces the support and at least partially defines a corresponding receiving space for the at least one electronics structure;
wherein the illumination passaging is configured to allow light to travel through the illumination passaging toward the corresponding receiving space to allow light to reach the at least one electronics structure to expose the at least one electronics structure to light while obstructing light from reaching the at least one electronics structure away from the illumination passaging; and
wherein the light shield assembly is configured to guide the light shield body along a thermal expansion pathway that corresponds to a thermal expansion profile of the light shield body.

A2. The light shield of statement A1, wherein the thermal expansion pathway allows the light shield body to travel along a first expansion axis, the first expansion axis extending from a center of thermal expansion of the light shield body in a direction generally parallel to the first face.

A3. The light shield assembly of statement A1, wherein the thermal expansion pathway of the light shield body comprises at least one of a lengthwise motion and a widthwise motion relative to the light shield body.

A4. The light shield assembly of statement A1, wherein the thermal expansion pathway is linear.

A5. The light shield assembly of statement A1, wherein the shape of the respective thermal expansion pathway is a function of a thermal gradient associated with the respective light shield, the thermal gradient being defined by the transfer of heat generated in a first portion of the light shield body in response to at least a first pulse of incoherent light.

A6. The light shield assembly of statement A5, wherein the light shield is operatively connected to a respective first support column and a respective second support column, wherein the first support column and the second support column are oriented parallel to one another along the first expansion axis associated with the first light shield.

A7. The light shield assembly of statement A6, wherein the first support column is configured to be received in a respective locating hole to restrict horizontal movement of the first support column relative to the at least one electronics structure positioned between the light shield body and the support, the first support column defining the center of thermal expansion of the light shield body.

A8. The light shield assembly of statement A6, wherein the second support column is configured to slidably engage a corresponding guide passage, the corresponding guide passage defining at least one side wall, the at least one side wall at least partially defining the thermal expansion pathway associated with the light shield body.

A9. The light shield assembly of statement A8, wherein a slot in the support defines the guide passage.

A10. The light shield assembly of statement A8, wherein a slot in the at least one electronics structure defines the guide passage.

A11. The light shield assembly of statement A8, wherein a slot in the first light shield defines the guide passage.

A12. The light shield assembly of statement A1, wherein the light shield is operatively connected to a first support member and a second support member;
wherein the thermal expansion pathway allows the light shield body to travel along a second expansion axis parallel to the light shield body and the at least one electronics structure, the second expansion axis intersecting with the first expansion axis at the center of thermal expansion of the first light shield;
wherein the first support member is configured to slidably engage a first guide passage, the first guide passage defining at least one first side wall, the at least one first side wall being oriented generally along the first expansion axis; and
wherein the second support member is configured to slidably engage a second guide passage, the second guide passage defining at least one second side wall, the at least one second side wall being oriented generally along the second expansion axis

A13. The light shield assembly of statement A12, wherein the light shield is operatively connected to a third support member;
wherein the thermal expansion pathway allows the light shield body to travel along a third expansion axis parallel to the light shield body and the at least one electronics structure, the third expansion axis intersecting with the first expansion axis and the second expansion axis at the center of thermal expansion of the first light shield; and
wherein the third support member is configured to slidably engage a third guide passage, the third guide passage defining at least one third side wall, the at least one third side wall being oriented generally along the second expansion axis.

A14. The light shield assembly of statement A1, wherein the at least one light shield comprises a plurality of light shields.

A15. The light shield assembly of statement A1, wherein the at least one electronics structure is at least partially located in the receiving space.

A16. The light shield assembly of statement A1, wherein the at least one electronics structure comprises a plurality of electronics structures, the at least one shield comprising a plurality of light shields, wherein each electronics structure is at least partially located in a receiving space associated with a single corresponding light shield.

A17. The light shield assembly of statement A1, wherein the at least one shield comprises a plurality of light shields, and wherein the at least one electronics structure is partially located in a plurality of receiving spaces each associated with a corresponding light shield.

A18. The light shield assembly of statement A1, wherein the at least one electronics structure comprises multiple repeated segments to be processed in a like manner.

A19. The light shield assembly of statement A18, wherein the at least one electronics structure is configured to be separated following the processing of the multiple repeated segments.

A20. The light shield assembly of statement A1, further comprising a light shield carrier configured to support the at least one light shield so that the second face of the light shield body faces the support.

A21. The light shield assembly of statement A20, wherein at least one slot is formed in the light shield carrier, the at least one slot having at least one side wall; and
wherein the at least one side wall at least partially defines the thermal expansion pathway associated with the light shield body retained by the light shield carrier.

A22. The light shield assembly of statement A20, wherein the at least one light shield comprises a plurality of light shields, the light shield carrier being configured to support the plurality of light shields so that the second face of each light shield body faces the support.

A22. The light shield assembly of statement A1, wherein the light shield assembly is configured to obstruct heat transfer across the at least one light shield from a first region of the at least one light shield to a second region of the at least one light shield.

A23. The light shield assembly of statement A22, wherein the light shield body comprises at least one thermal break.

A24. The light shield assembly of statement A1, wherein the at least one light shield comprises a support column extending downward from the light shield body.

A25. The light shield assembly of statement A24, wherein the support column is folded downward from the light shield body.

B1. A light shield assembly comprising a support, a light shield carrier, and a plurality of light shields, each light shield having a body that defines at least one illumination passage through which light can pass to process at least one electronics structure;
wherein the light shield carrier is configured to support each light shield carrier in a manner that permits the body of the light shield to expand in response to exposure to one or more pulses of light.

B2. The light shield assembly of statement B1, wherein the light shield carrier is configured to permit the body of each light shield to expand outwardly relative to a predetermined center of thermal expansion of the light shield.

B3. The light shield assembly of statement B1, wherein the light shield carrier is configured to be releasably coupled to the support to provide shielding for the at least one electronics structure.

C1. A method of thermally processing at least one electronics structure, the method comprising:
providing at least one electronics structure;
arranging shielding with respect to the at least one electronics structure; and
illuminating the shielding and the at least one electronics structure for thermally processing the at least one electronics structure, the shielding at least partially overlying the at least one electronics structure to obstruct illumination of some of the at least one electronics structure.

C2. The method of statement C1, wherein the electronics structure comprises an electronics structure including multiple electronics structure portions.

C3. The method of any statement above, wherein each electronics structure portion is partially shielded by the shielding and partially exposed to the illumination to thermally process the electronics structure portion.

C4. The method of any statement above, wherein the electronics structure portions are repeated electronics structure portions.

C5. The method of any statement above, wherein the electronics structure portions have the same construction.

C6. The method of any statement above, wherein the electronics structure comprises an opening through which support structure supporting the shielding relative to the electronics structure passes.

C7. The method of any statement above, wherein the shielding comprises a plurality of shields.

C8. The method of any statement above, wherein the shields are separate from and moveable with respect to each other.

C9. The method of any statement above, wherein each shield corresponds with an associated electronics structure portion.

C10. The method of any statement above, wherein the shields are carried by a shield carrier.

C11. The method of any statement above, wherein arranging the shielding comprises moving a carrier carrying the shields into position with respect to the electronics structure.

C12. The method of any statement above, further comprising separating the thermally processed multiple electronics structure portions to form a plurality of separate electronics structure portions.

C13. The method of any statement above, wherein illuminating the at least one electronics structure comprises illuminating each electronic structure portion to provide the illuminated segment of the electronic structure portion with a radiant exposure of at least 20 J/cm².

C14. The method of any statement above, wherein thermally processing the at least one electronics structure comprises soldering each of the electronics structure portions.

C15. The method of any statement above, wherein thermally processing the at least one electronics structure comprises sintering each of the electronics structure portions.

C16. The method of any statement above, wherein thermally processing the at least one electronics structure comprises crosslinking each of the electronics structure portions.

C17. The method of any statement above, further comprising permitting thermal expansion of the shielding.

C18. The method of any statement above, further comprising maintaining registration of illumination passages of the shielding with respect to respective electronics structure portions while permitting thermal expansion of the shielding.

C19. The method of any statement above, further comprising maintaining registration of multiple illumination passages of the shielding in registration with components of the at least one electronics structure while the shielding thermally expands.

C20. The method of any statement above, further comprising maintaining illumination passaging of the shielding in registration with segments of the at least one electronics structure while the shielding thermally expands.

C21. The method of any statement above, wherein the shielding is permitted to thermally expand in association with an expansion mechanism.

C22. The method of any statement above, wherein the expansion mechanism permits thermal expansion in a predetermined direction.

C23. The method of any statement above, wherein the expansion mechanism comprises a nonlinear expansion guide.

C24. The method of any statement above, wherein the expansion mechanism comprises multiple expansion guides .

C25. The method of any statement above, wherein the multiple expansion guides each define an expansion axis, the expansion axes intersecting at a centroid, the centroid being located proximate illumination passaging of the shielding.

C26. The method of any statement above, further comprising changing a relative position of the at least one electronics structure with respect to a source of the illumination.

C27. The method of any statement above, wherein illuminating comprises exposing the shielding and electronics structure to illumination in multiple illumination areas.

C28. The method of any statement above, wherein the multiple illumination areas include a first illumination area and a second illumination area, the first and second illumination areas overlapping.

C29. The method of any statement above, wherein illuminating in the multiple illumination areas comprises exposing the shielding and at least one electronics structure to multiple pulses of light in each illumination area.

C30. The method of any statement above, wherein illuminating comprises emitting broadband light.

C31. The method of any statement above, wherein illuminating comprises emitting incoherent light.

C32. The method of any statement above, wherein illuminating comprises flashing a flashlamp to flash light on the shielding and at least one electronics structure.

C33. The method of any statement above, further comprising obstructing heat transmission across the shielding with thermal breaks in the shielding.

C34. The method of any statement above, wherein the electronics structure portions are distinct from and moveable relative to each other.

What is claimed is:

1. A method of thermally processing at least one electronics structure, the method comprising:
providing multiple electronics structure portions;
arranging shielding with respect to electronics structure portions; and
illuminating the shielding and the electronics structure portions with one or more pulses of incoherent light for thermally processing the electronics structure portions, the shielding at least partially overlying each respective electronics structure portion to obstruct illumination of some of the respective electronics structure portion.

2. The method of claim 1, wherein the electronics structure portions are repeated electronics structure portions.

3. The method of claim 1, wherein the electronics structure portions have the same construction.

4. The method of claim 1, wherein the electronics structure portions are part of an electronics structure comprising an opening through which support structure supporting the shielding relative to the electronics structure passes.

5. The method of claim 1, wherein the shielding comprises a plurality of shields.

6. The method of claim 5, wherein the shields are separate from and moveable with respect to each other.

7. The method of claim 5, wherein each shield corresponds with an associated electronics structure portion.

8. The method of claim 5, wherein the shields are carried by a shield carrier.

9. The method of claim 5, wherein arranging the shielding comprises moving a carrier carrying the shields into position with respect to the electronics structure portions.

10. The method of claim 1, wherein the electronics structure portions are part of an electronics structure, and further comprising separating the thermally processed electronics structure portions to form a plurality of separate electronics structure portions.

11. The method of claim 1, wherein illuminating electronics structure portions comprises illuminating each electronic structure portion to provide an illuminated segment of the electronic structure portion with a radiant exposure of at least 20 J/cm².

12. The method of claim 1, wherein thermally processing the electronics structure portions comprises soldering each of the electronics structure portions.

13. The method of claim 1, wherein thermally processing the electronics structure portions comprises sintering each of the electronics structure portions.

14. The method of claim 1, wherein thermally processing the electronics structure portions comprises crosslinking each of the electronics structure portions.

15. The method of claim 1, further comprising permitting thermal expansion of the shielding.

16. The method of claim 15, further comprising maintaining registration of illumination passages of the shielding with respect to respective electronics structure portions while permitting thermal expansion of the shielding.

17. The method of claim 15, further comprising maintaining registration of multiple illumination passages of the shielding in registration with respective components of the electronics structure portions while the shielding thermally expands.

18. The method of claim 1, further comprising changing a relative position of the electronics structure portions with respect to a source of the illumination after illuminating a first of the electronics structure portions and before illuminating a second of the illumination structure portions.

19. The method of claim 1, wherein illuminating comprises exposing the shielding and the electronics structure portions to illumination in multiple illumination areas

20. The method of claim 19, wherein the multiple illumination areas include a first illumination area and a second illumination area, the first and second illumination areas overlapping, and wherein illuminating comprises emitting more than one pulse of incoherent light in the first illumination area and the second illumination area.

21. The method of claim 1, wherein the electronics structure portions are distinct from and moveable relative to each other.
